(19) United States
(12) Patent Application Publication
(10) Pub. No.: US 2006/0093103 A1
(43) Pub. Date: May 4, 2006

(54) Technique for generating and accessing organized information through an information assistance service

(76) Inventors: Timothy A. Timmins, Beaverton, OR (US); John S. Miller, Canby, OR (US)

Correspondence Address: ALEX L.YIP;KAYE SCHOLER LLP, 425 PARK AVENUE, NEW YORK, NY, 10022, US

(21) Appl. No.: 10/977,600

(22) Filed: Oct. 29, 2004

(51) Int. Cl. H04M 11/00; H04M 1/64

(52) U.S. Cl. 379/88.19; 379/88.14

(57) ABSTRACT

An information assistance service is provided whereby a company can access records in a customer relationship management (CRM) system. The records may be organized in folders according to different groups in the company, e.g., a sales force of the company. To generate a record, a member of the group may call the information assistance service to input, through an operator or a voice server, various items of information, e.g., his/her name, subject information, an account name, sales lead information, notes/comments, etc. The voice information may be converted to textual data to fill various fields of the record. Records generated in this manner by one or more members of the group may be assembled in a group folder associated with the group. Records in the group folder may be accessed by members of the group through the information assistance service. A calling member who contacts the information assistance service to access the group folder may review the records therein and play selected records or portions thereof. The calling member may also request the information assistance service to sort the records according to a selected parameter, and/or to search for desired records based on one or more selected parameters.

### FIELD OF THE INVENTION

The invention relates to a communications system and method, and more particularly to a system and method for managing information over a communication network.

### BACKGROUND OF THE INVENTION

Many companies and organizations utilize customer relationship management (CRM) systems to organize and manage a variety of tasks including their sales activities, marketing efforts, supply chain monitoring, etc. A CRM system typically gathers information from a variety of sources including employees and clients, and organizes and processes the information to allow a company to streamline its operations.

Because a CRM system relies on information provided by various sources, data maintained or generated by such a system is only as timely as the information received. In some instances this can create significant problems. For example, the manner in which many CRM systems collect information is not well tailored to a typical sales force. In many cases, a salesperson is expected to submit a written report as a record of a sales meeting, detailing the time, place, sales leads obtained, issues discussed during the meeting, etc. In many cases, the written reports are created through a user interface provided by the CRM system. Typically, reports generated by various salespersons in a company's sales force are gathered and stored in the CRM system, and a sales manager subsequently reviews the reports in an attempt to extract from them as much useful information as possible. This approach to gathering sales information is slow, and in today's competitive marketplace, impractical if not ineffective. Sales personnel are often on the road and cannot easily write a report from their vehicles. As a result, written reports of sales meetings are commonly generated days, if not weeks, after the meeting in question. Perhaps worse, this approach does not provide a convenient way for a sales manager to obtain information of sales activities in advance. If a salesperson receives a call at 8:00 a.m. in the morning from a client who wishes to schedule a meeting for 11:00 a.m. the same day, the salesperson in many cases may not have time to generate a written report before the meeting. The salesperson can, of course, call the sales manager by telephone and tell him/her directly of the meeting. However, without a uniform, integrated approach to collecting such information, the sales manager can have no assurance that he/she receives all relevant information on a timely basis.

### SUMMARY OF THE INVENTION

The invention overcomes the prior art limitations by providing effective access to an “information depot” such as a prior art CRM system to fully exploit its functionality. By taking advantage of the infrastructure of an information assistance service which has been established for providing, e.g., directory assistance, the invention allows a user to make a voice call to the information assistance service to request, among others, entry of data to, e.g., a remote CRM system, where information is organized in records. Each record includes a plurality of fields therein, and the records are associated with one or more folders. In accordance with the invention, identity information concerning the user (e.g., an ANI) is automatically derived from call set-up signals associated with the voice call. Verbal information is elicited from the user for filling one or more fields of a record. The verbal information is then converted to data corresponding thereto. The one or more fields of the record are filled with the data. Based on the identity information, the user is associated with a selected one of the folders. The record is transmitted to the remote CRM system, where the record is stored in association with the selected folder.

In accordance with an aspect of the invention, records in a folder in the CRM system may be accessed by a user via a voice call to the information assistance service. The user is associated with the folder based on identity information concerning the user, which is automatically derived from call set-up signals associated with the voice call. One or more records associated with the folder are identified based on content in at least one of the fields of the one or more records. Data in the identified records is verbally conveyed to the user, e.g., by an operator or a voice device at the information assistance service.

### BRIEF DESCRIPTION OF THE DRAWINGS

FIG. 1 illustrates a communication arrangement including information/call centers for providing an information assistance service in accordance with the invention;

FIGS. 2A and 2B are block diagrams of components of an information/call center of FIG. 1;

FIG. 3 is a block diagram of a customer relationship management (CRM) gateway in the information/call center;

FIG. 4A is a table for maintaining user information, in accordance with the invention;

FIG. 4B is a table for maintaining customer information, in accordance with the invention;

FIG. 5 illustrates a Login graphical user interface (GUI) utilized in the information assistance service;

FIG. 6 shows a menu of options provided to a caller in connection with a CRM group folder, in accordance with the invention;

FIG. 7 illustrates a GUI used to generate a new record in a CRM group folder, in accordance with the invention;

FIG. 8 is a flowchart depicting a routine for generating a record, in accordance with the invention;

FIG. 9 illustrates a record containing information received from a caller, in accordance with the invention;

FIG. 10 illustrates a CRM group folder in accordance with the invention;

FIG. 11 is a flowchart depicting a routine for presenting information in response to a review records request, in accordance with the invention;

FIG. 12 illustrates a GUI containing information concerning records retrieved in response to a caller's review records request, in accordance with the invention;

FIG. 13 is a flowchart depicting a routine for playing a selected record to a caller, in accordance with the invention;

FIG. 14 is a flowchart depicting a routine for sorting records based on an author name parameter, in accordance with the invention;

FIG. 15 illustrates a GUI containing information concerning records sorted based on an author name parameter, in accordance with the invention;

FIG. 16 is a flowchart depicting a routine for sorting records based on an account parameter, in accordance with the invention;

FIG. 17 illustrates a GUI containing information concerning records sorted based on an account parameter, in accordance with the invention;

FIG. 18 is a flowchart depicting a routine for searching for one or more records within a time range, in accordance with the invention;

FIG. 19 illustrates a GUI containing information concerning records resulting from a search based on a time range, in accordance with the invention;

FIG. 20 is a flowchart depicting a routine for searching for one or more records based on an author name parameter, in accordance with the invention;

FIG. 21 illustrates a GUI containing information concerning records resulting from a search based on an author name parameter, in accordance with the invention;

FIG. 22 is a flowchart depicting a routine for searching for one or more records based on a subject parameter, in accordance with the invention; and

FIG. 23 illustrates a GUI containing information concerning records resulting from a search based on a subject parameter, in accordance with the invention.

### DETAILED DESCRIPTION

Many companies and organizations utilize customer relationship management (CRM) systems to organize and manage a variety of tasks, including their sales activities, marketing efforts, supply chain monitoring, etc. A CRM system typically gathers information from a variety of sources including a company's employees, and/or clients, and organizes and processes the information to allow a company to streamline its operations. The invention is directed to an information assistance service facilitating generating and accessing organized information, e.g., in a CRM system over a communication network, e.g., a telephone network.

By way of example, suppose that the XYZ Widget Company has many of its sales personnel frequently on the road visiting existing and prospective clients. The company may rely on a CRM system to collect and process information concerning its sales activities. Suppose further that in the ordinary course of its operations, the CRM system maintains a folder containing records pertaining to various meetings and other activities performed by the company's sales force. A folder maintained by a CRM system for a group, e.g., the sales force, is referred to herein as a “CRM group folder.”

In accordance with the invention, to facilitate the entry of sales information into the CRM system in a timely and efficient manner, the company and its members register with the inventive information assistance service. After registering with the service, members of the company (e.g., salespeople) can conveniently access the company's CRM group folder to generate new records and/or review existing records. A member of the company contacts the inventive information assistance service, e.g., by telephone, and accesses the company's CRM group folder through an operator. The term “operator” used herein broadly encompasses entities that are capable of providing assistance in a telecommunications environment, including without limitation human and nonhuman operators, voice response/recognition capabilities, web-/WAP-enabled operator services, and other automated and electronic access. Upon prompting by an operator, the calling member provides, by voice, various items of “header” information, e.g., his/her name, subject information, an account name, etc. The caller may also provide, by voice, information to be included in the “body” of the record, which may include sales lead information, messages, notes/comments, etc. The record including the header and body after their creation is stored in the company's CRM group folder. Additional header information including the date and time the record was created may also be generated automatically and included in the record. Multiple records generated in this manner by one or more members of the company's group may be stored in the company's CRM group folder.

In an embodiment of the invention, the information in a record initially provided verbally by a group member to the information assistance service is automatically converted to textual data using, e.g., a conventional speech-to-text converter in a voice server before the record is stored. In an alternative embodiment, an operator enters the information provided verbally into various fields of a record in the form of textual data. In either embodiment, information in such records may be subsequently accessed and read by an operator, or by a voice server using a conventional text-to-speech converter. In another embodiment, the information stored in a record comprises one or more digital recordings of the calling member's actual utterances corresponding to different fields of the record. These digital recordings may be replayed when the record is subsequently accessed.

Records stored in the company's CRM group folder may be accessed by members of the company by telephone. A member of the company who calls the information assistance service to access the CRM group folder may review the records stored therein and play selected records or portions thereof. The calling member may also be able to sort, through the information assistance service, the records according to one or more parameters, and/or may search for one or more desired records based on selected parameters.

In one embodiment, when a member requests that all or a portion of a selected record be played, the desired portion(s) of the record is played to the requesting member over the telephone by a voice server capable of converting textual data to the corresponding voice announcement(s). In an alternative embodiment, an operator viewing the selected record displayed on a GUI may read the desired portion(s) of the selected record to the requesting member. In another embodiment, the digital voice recording(s) associated with the desired portion(s) of the selected record may be replayed by a voice server to the requesting member.

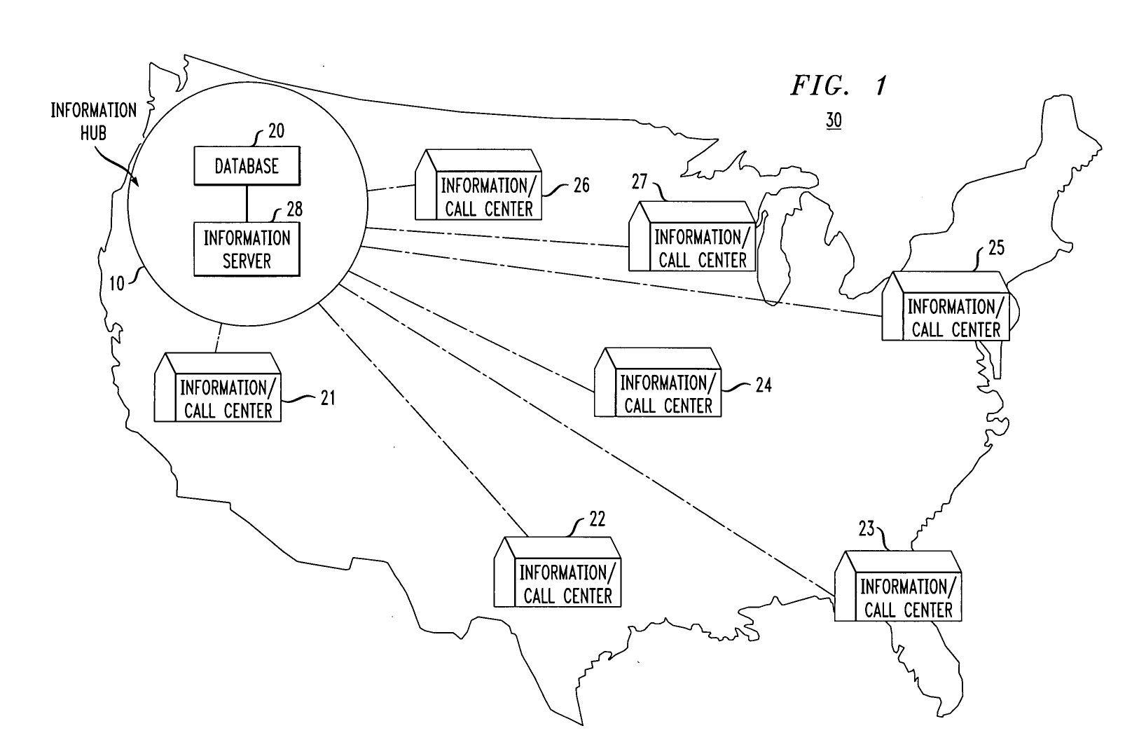

FIG. 1 illustrates a communication arrangement for interacting with a customer relationship management (CRM) system in accordance with the invention. This communication arrangement includes wide area network (WAN) 30 covering an extensive area. WAN 30 may be an Internet-based network such as the World Wide Web or a private intranet-based network. WAN 30 connects operators dispersed throughout a wide coverage area in information/call centers 21 through 27. One or more information hubs 10 are also included in WAN 30. An information hub 10 includes one or more information servers 28 which may comprise one or more CRM systems (not shown), and one or more databases 20 in which, among others, CRM records are stored and organized in CRM group folders. Such records may also be stored locally at one or more of the information/call centers. The records at different centers may be synchronized. Synchronized databases provide necessary backup as well as support to roaming mobile device users. It should be noted that information hub 10 including information server 28 may be located at the premises of a customer (such as XYZ Widget Company), or at the premises of the inventive service provider.

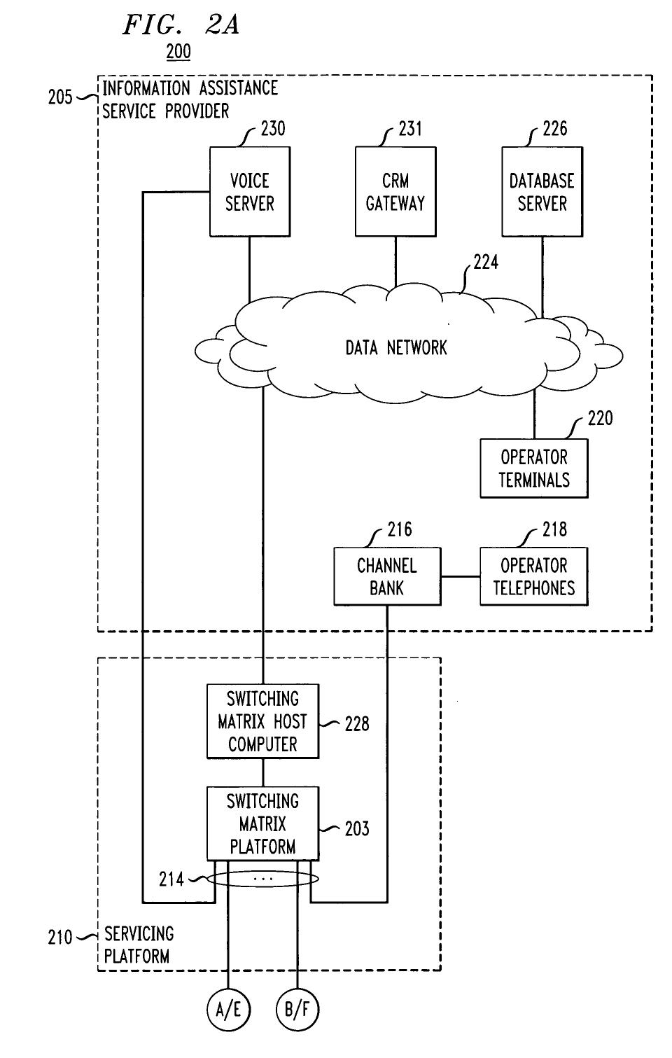

Referring to FIGS. 2A and 2B, information/call center 200 (which generically represents one of aforementioned information/call centers 21 through 27) is attended by operators, which includes information assistance service provider 205 and servicing platform 210. It should be noted that even though both provider 205 and servicing platform 210 appear in the same figure, they may or may not be located in the same geographic area. Servicing platform 210 comprises switching matrix host computer 228, and switching matrix platform 203, which is connected via T1 communication links 214 to, among others, voice server 230 and channel bank 216 in provider 205.

Channel bank 216 is used to couple multiple operator telephones 218 to platform 203. The operators in center 200 are further equipped with operator terminals 220, each of which includes a display unit and a keyboard with associated dialing pad. Operator terminals 220 are connected over data network 224 to one or more database server(s) 226 (although only one is shown here). Database server 226 provides access to, among others, directory information from multiple sources. Database server 226 enables the operator to provide a directory assistance service for searching directory information not just by name and address (sometimes city or area code) of a desired party, but also by type of goods/services and/or geographical region of a desired entity.

Data network 224 further connects to voice server 230, information server 28, and switching matrix host computer 228, which in turn is connected to switching matrix platform 203 via a data link. Data network 224 includes, but is not limited to, local area network (LAN) 227, best seen in FIG. 2B. LAN 227 may connect to other similar remote LANs 229 to form WAN 30 in FIG. 1. LANs 227 and 229 are connected to one another and to Internet 221 via routers 225.

A user's telephone, computer, PDA or other telecommunications device 224 communicates via communications network 246 which is connected to carrier network node 242 and carrier switching center 240. T1 voice links 212 provide connection between the information/call center's switching matrix platform 203 and carrier's switching center 240, through which incoming information assistance calls are received. T1 voice links 212 further provide connection to the carrier switching center 240 through which outgoing calls are placed over communications network 246 (which network may be different than that used for incoming calls). Similarly, T1 data links 213 provide a signaling connection between the information/call center's node (not shown) and carrier network node 242, through which incoming and outgoing signaling messages are transported. The information/call center node is contained within switching matrix platform 203, but one with skill in the art will appreciate that the information/call center node could be a physically distinct component.

The operation of switching matrix platform 203 is governed by computer-readable instructions stored and executed on switch matrix host computer 228. In this illustrative embodiment, platform 203 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on center 200 and platform 203 for each corresponding function.

Voice server 230 is connected via data network 224 to computer 228 (to which it acts as a slave processor) and via one or more T1 links to switching matrix platform 203. Each voice server 230, when more than one is employed in information/call center 200, connects to switching matrix platform 203 via a separate T1 link. Voice server 230 comprises a general purpose computer incorporating one or more voice cards, which serve as the interface between server 230 and the T1 span to switching matrix platform 203. One such voice card in server 230 monitors and controls communications over the T1 span. Its capabilities include telephone tone (e.g., DTMF or MF) detection and generation, voice recording and playback, and call progress analysis. Voice server 230 in this instance also contains a voice recognition device for receiving verbal input from a party connected thereto, and conventional converters for speech-to-text and text-to-speech conversions. Voice server 230 is employed to play the constantly repeated parts of an operator's speech, including, for example, the caller's desired telephone number where requested, and possibly other information. At appropriate stages in a call progression, switch matrix host computer 228 initiates a voice path connection between voice server 230 and switching matrix platform 203 such that the user, or the user and the operator, are able to hear whatever pre-recorded speech is played on that connection by voice server 230. Computer 228 then instructs voice server 230, via data network 224, what type of message to play, and passes data parameters that enable voice server 230 to locate the message appropriate to the call state.

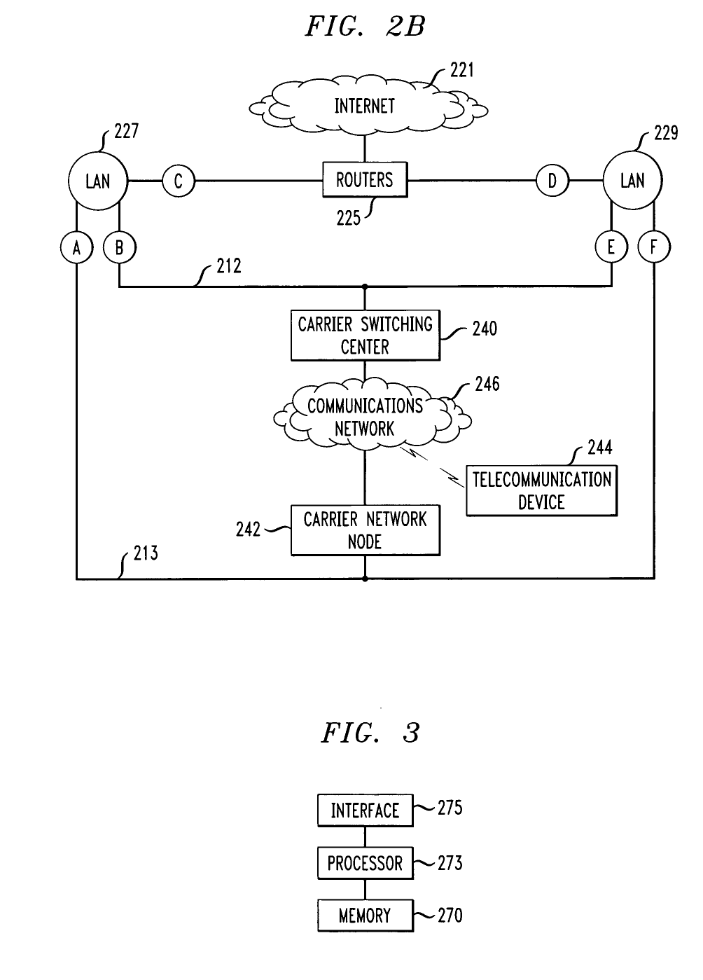

FIG. 3 illustrates customer relationship management (CRM) gateway 231, which includes processor 273, memory 270 and interface 275. Instructed by software stored in memory 270, processor 273 is configured for communicating with information server 28, and retrieving the same. Interface 275 provides processor 273 with access to data network 224 and thence to Internet 221 and/or WAN 30. For example, in response to signals from terminal 220, processor 273 may communicate with information server 28 in order to retrieve one or more data records stored on database 20. Processor 273 may cause one or more data records, or portions thereof, to be downloaded from server 28. Selected portions of the records may be transmitted to terminal 220 for presentation to a human operator who in turn conveys the same to a caller, or to voice server 230 which communicates the same to the caller in an automated voice.

Users of a particular telephone carrier may dial, speak or otherwise communicate predetermined access digits, access codes or retail numbers, or input a predetermined address or a Uniform Resource Locator (URL) established for information assistance service. The instant example assumes that a caller dials, e.g., “411,” “*555,” “555-1212,” “1-800-555-1212,” “00,” or other designated access numbers. The participating telephone carrier's own switching system will then reroute the call to information/call center 200 (via a T1 channel), where it appears as an incoming call.

Automatic call distribution (ACD) logic is used to queue (if necessary) and distribute calls to operators in the order in which they are received, and such that the call traffic is distributed evenly among the operators. In other embodiments, other distribution logic schemes may be utilized, such as skills-based routing based on, e.g., a preferred call handling method specified by a user profile, or a priority scheme for preferred callers. The queue is maintained by switching matrix host computer 228.

When a customer, such as a company, registers with the inventive information assistance service, the company provides, to the inventive service, information needed to communicate with the company's CRM system, to access CRM group folders, and to pass any security checks as necessary for the third party CRM application. The customer additionally provides to the information assistance service provider a list of the customer's members. As part of the registration procedure, identifying information for each member is entered at a customer database, including username, password, and telephone number of the particular telecommunications device, e.g., a wireless telephone, which the member would use to call the information assistance service in the future. It is particularly advantageous to use such a phone number (also known as a mobile directory number (MDN) in the case of a wireless telephone number) to identify the member since the calling number would be automatically captured as an ANI at information/call center 200 when the member calls. Specifically, platform 203 in center 200 in a well-known manner derives the ANI from the call set-up signals associated with the member's call.

Also during registration, members of a customer may be granted different access rights with respect to a CRM group folder according to their status and/or position within the company. For example, in the case of the XYZ Widget Company, salespersons may be granted a first access right enabling them to generate records, and to review records in the CRM group folder, but not allowing these individuals to revise or delete records within the folder. On the other hand, a sales manager may be granted the same rights as a salesperson, plus additional rights to revise and delete the stored records.

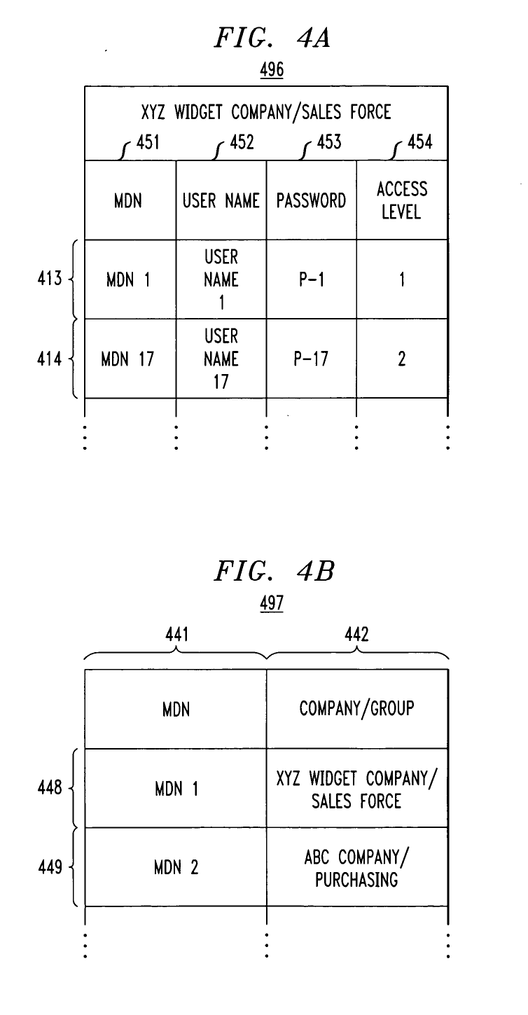

FIG. 4A illustrates a customer table 496 that may be maintained by the provider of the inventive service in a customer database for the XYZ Widget Company. Column 451 contains an identifier (in this instance, an MDN) for a member of the sales force of the XYZ Widget Company. Column 452 contains a user name associated with the member. The user name may be, e.g., a derivation of the member's actual name. Column 453 contains a password which the member may be required to provide when using the inventive information assistance service. Column 454 contains data indicating an access level accorded to the respective member. Referring to row 413, for example, the member associated with the identifier “MDN 1” has user name “User Name 1,” password “P-1,” and access level 1, which is associated with a particular set of rights concerning a CRM group folder. In contrast, referring to row 414, the member associated with the identifier “MDN 17” has an access level of 2, according him or her a different set of rights with respect to the CRM group folder.

The provider of the inventive service additionally maintains a table denoted 497 in FIG. 4B to facilitate access to CRM records associated with a company's group. Table 497 associates one or more member identifiers with various groups of the same or different companies. Column 441 contains an identifier (in this instance, an MDN) for an individual member of a respective group; column 442 contains an identifier of the respective group. When the inventive information assistance service receives a call from a member of one of the groups, the caller's MDN is captured at information/call center 200. CRM gateway 231 communicates the MDN to information server 28, which examines table 497 to determine which customer table to access. Supposing, for example (referring to row 448), that a call is received from a communications device having the identifier “MDN 1,” server 28 examines table 497 and determines that the caller is associated with the XYZ Widget Company/Sales Force. Accordingly, server 28 accesses customer table 496, associated with the sales force of the XYZ Widget Company, and retrieves the particular member's user name, password, and access level. This information is communicated to gateway 231.

Suppose that on June 10, YYYY, an individual named Bill Tyler, working as a salesman for the XYZ Widget Company, schedules a meeting with a client, Acme Hardware. Although the meeting is scheduled for June 12, YYYY, Bill wishes to inform his sales manager of the scheduled meeting immediately. Accordingly, on June 10 Bill uses telecommunications device 244, e.g., a wireless phone, to call the inventive information assistance service, for the purpose of reporting the scheduled meeting.

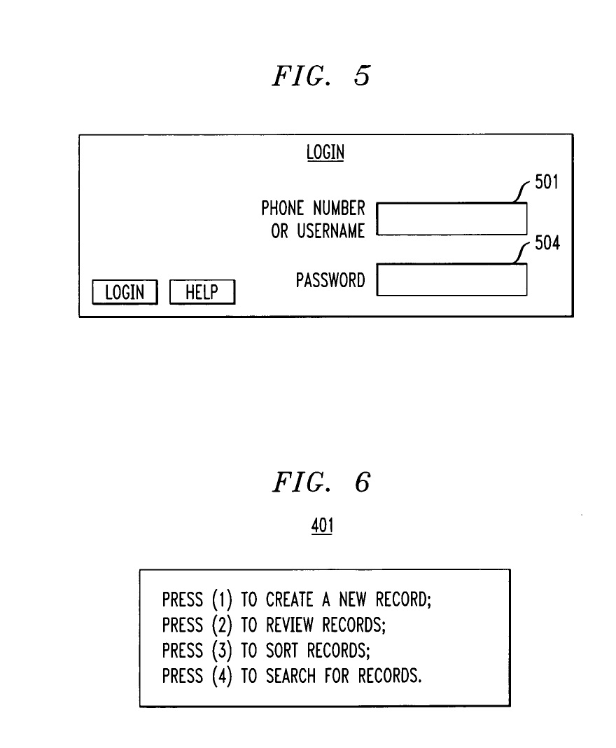

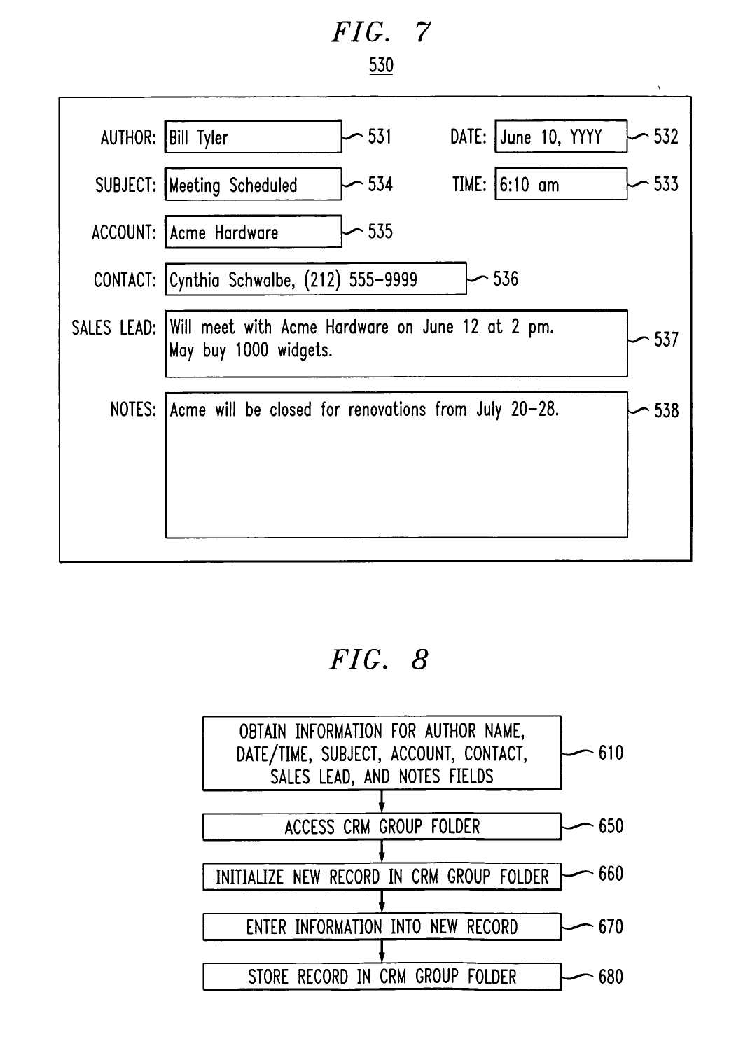

Let's say the call is routed to information assistance/call center 200, where an operator attends to the call. After Bill communicates his/her needs, e.g., to access the CRM group folder, the operator at terminal 220 establishes communications with information server 28 through WAN 30. In response, server 28 presents on terminal 220 a Login graphical user interface (GUI), which is illustrated in FIG. 5. As shown in FIG. 5, the operator is prompted to enter the caller's phone number or user name to identify the caller, and a password to verify that the caller is a registered user of the inventive information assistance service. The ANI received associated with the caller's communication device, which corresponds to its MDN, may be automatically provided at entry 501 of the Login GUI by server 28, thereby obviating the need of the operator's eliciting from the caller, and entering, the required phone number or user name. (In the event that such an MDN is not automatically available, or where the caller is accessing the subject service from an unknown point or the operator suspects that the caller calls from a phone number other than the registered phone number, the operator may verify/obtain the necessary identifying information with/from the caller.) At entry 504, the operator enters the password provided by the caller to complete the login process. The login information is then transmitted to server 28, where it verifies the received MDN and password. In the manner described above, server 28 determines based on the MDN that Bill Tyler is a user with access rights including the right to generate records for the CRM group folder associated with the sales force of the XYZ Widget Company. Server 28 informs gateway 231 of Bill's status and access rights. A copy of the CRM group folder is provided to CRM gateway 231. At this point, CRM gateway 231 may cause voice server 230 to play a prerecorded welcome message such as, “Welcome to the CRM Information Assistance Service.”

After the authorization procedure, voice server 230 plays a menu of options such as menu 401 shown in FIG. 6, which is reproduced below for convenience.

Press (1) to create a new record;

Press (2) to review records;

Press (3) to sort records;

Press (4) to search for records.

In this example, because Bill wishes to generate a record of his scheduled meeting with Acme Hardware, he presses (1) to create a new record. In response, voice server 230 transmits a signal containing Bill's selection to gateway 231, which then causes Bill's call to be transferred to an operator at terminal 220, and a Record GUI denoted 530 in FIG. 7 to be displayed on terminal 220. Record GUI 530 includes fields for header information, namely, field 531 for registering the name of the record's author, fields 532 and 533 for the date/time the record is generated, field 534 for subject information, field 535 for account information, and field 536 for contact information. The body of the record includes field 537 for registering sales lead information, and field 538 for registering a note or message by the author.

FIG. 8 is a flowchart depicting a routine for generating a record based on information received from a member of a registered group. Referring to step 610, information for fields 531-538 of Record GUI 530 is obtained. Selected items of information may be obtained from the caller, specifically, information pertaining to the author's name, subject, account, contact(s), any sales lead(s), and any note or comment that the caller wishes to record. Gateway 231 may also complete one or more fields automatically. For example, the name of the author may be entered in field 531 based on the MDN received during the call. The operator may confirm the author name to be sure that the caller is indeed the registered member associated with the MDN. Date and time information is entered automatically in fields 532 and 533.

The operator prompts the caller to provide data for each of the remaining fields of Record GUI 530: subject information, account information, contact information, sales lead information, and any note or message which the caller wishes to record. The caller provides these items of data verbally, and the operator types the information into the respective fields of Record GUI 530.

In the illustrative example, Bill Tyler tells the operator that the subject is “Meeting Scheduled,” the account is “Acme Hardware,” and the contact's name and telephone number are “Cynthia Schwalbe, (212) 555-9999.” Bill further tells the operator that the sales lead is “Will meet with Acme Hardware on June 12 at 2 pm. May buy 1000 widgets.” When asked whether he wishes to record a note or comment, he states, “Acme will be closed for renovations from July 20-28.” The operator types Bill's responses into the appropriate fields of Record GUI 530 as they are received.

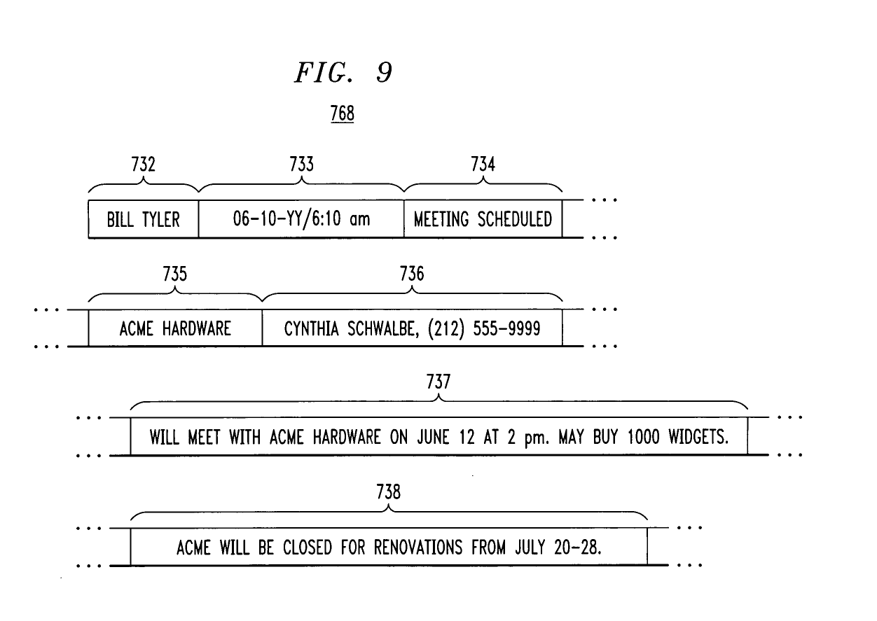

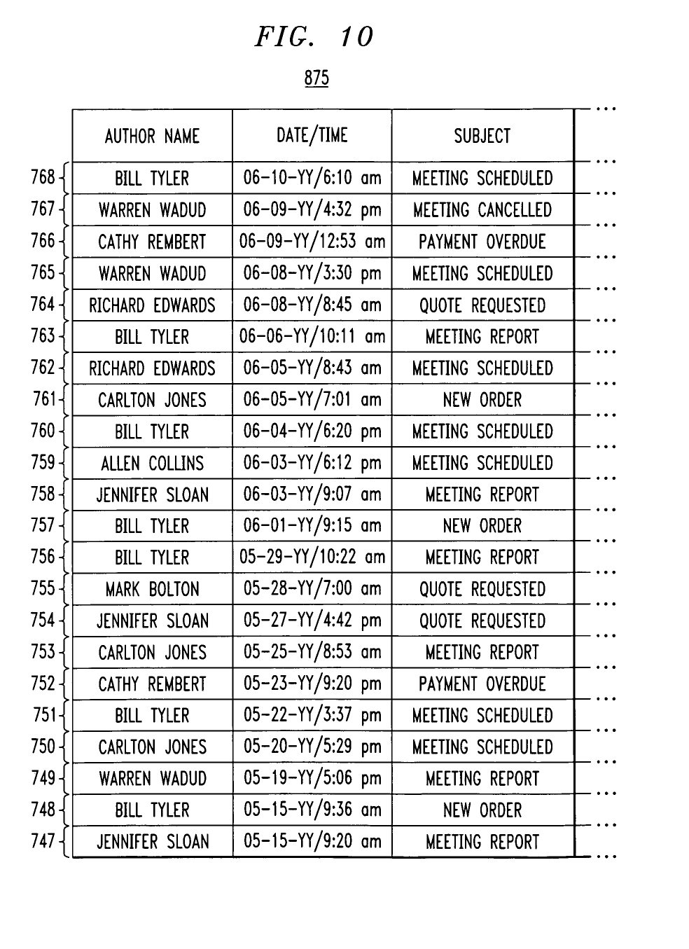

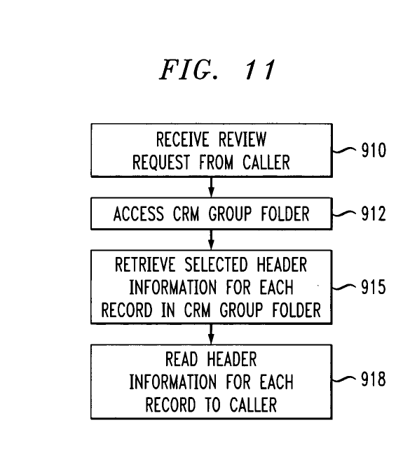

At step 650, gateway 231 accesses the XYZ Widget Company CRM group folder, and at step 660 initializes a new record within the CRM group folder to store the information received from Bill. At step 670, the information contained in various fields of Record GUI 530 is entered in the newly created record. FIG. 9 illustrates record 768 that may be generated based on the information received from Bill Tyler. Fields 732-738 contain author name information, date/time information, subject information, account information, contact information, sales lead information, and note information, respectively.

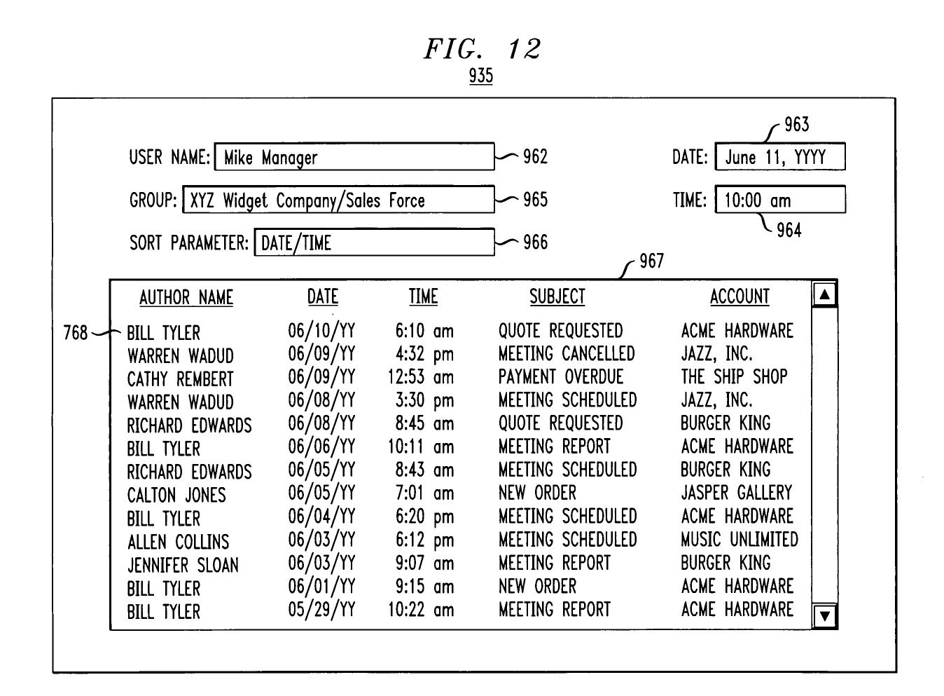

At step 680, the new record 768 containing the information received from Bill Tyler is stored in the CRM group folder associated with the sales force of the XYZ Widget Company. FIG. 10 shows a CRM group folder 875 which may be maintained by server 28, and which includes various records generated by members of the sales force of the XYZ Widget Company. CRM group folder 875 illustratively includes records 747-768, which are arranged chronologically. For example, record 768, which was generated by Bill Tyler on June 10, YYYY and is shown in FIG. 9, is the most recent record stored in CRM group folder 875. Other records by Bill Tyler, including record 763 (dated June 6, YYYY) and record 760 (dated June 4, YYYY) are also included in CRM group folder 875. It should be noted that in alternative embodiments, the records in CRM group folder 875 may be arranged according to parameters other than by date/time. CRM group folder 875 may be stored in, e.g., database 20. Alternatively, CRM group folder 875 may be stored in a memory (not shown) within information/call center 200.

It should be noted that although in this illustrative example, Bill conveys information to an operator, who in turn enters the information into GUI 530, in another embodiment, a caller may provide information for various fields of a record in response to prompts generated by voice server 230. As discussed above, voice server includes speech-to-text conversion capabilities for converting voice information to the corresponding textual text data. For example, the caller's voice utterances may be converted to textual data by a speech-to-text converter (not shown) in server 230 for the various fields of the record, and the resulting record stored in the CRM group folder. Alternatively, voice utterances by a caller may be converted to digital audio recordings and stored in a CRM record.

Subsequently, a registered member may access the records in CRM group folder 875. Continuing the illustrative example, suppose now that Mike Manager, who works as a sales manager at the XYZ Widget Company, wishes to gather information about the recent activities of his sales personnel. Accordingly, Mike calls the inventive information assistance service and logs into the service as discussed above with reference to FIG. 5. Based on the MDN received with Mike's call, server 28 examines table 497 and determines that Mike is a member of the sales force of the XYZ Widget Company. Accordingly, server 28 accesses and examines table 496 and determines that Mike is a registered user having enhanced access rights including, e.g., rights to review, search, read, and delete the records in CRM group folder 875. Server 28 informs gateway 231 of Mike's status and access rights.

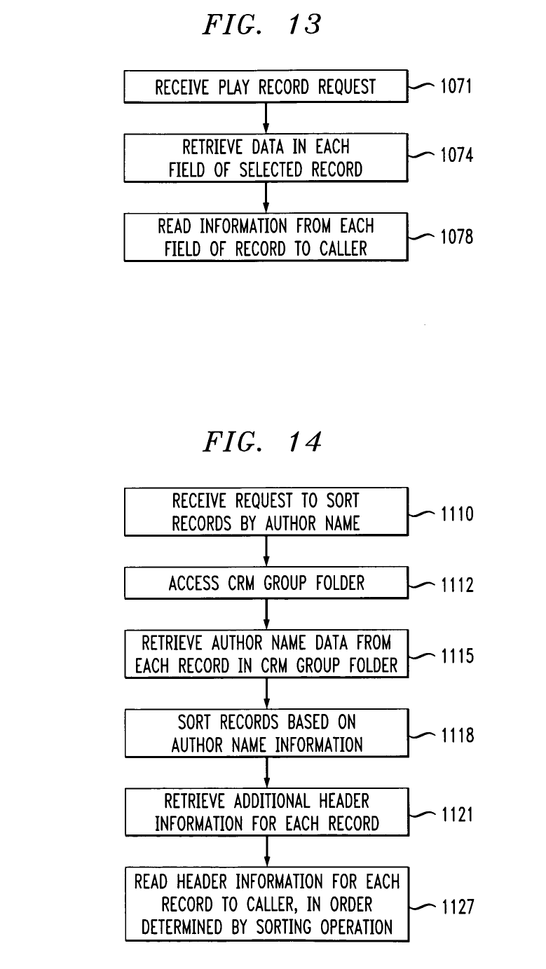

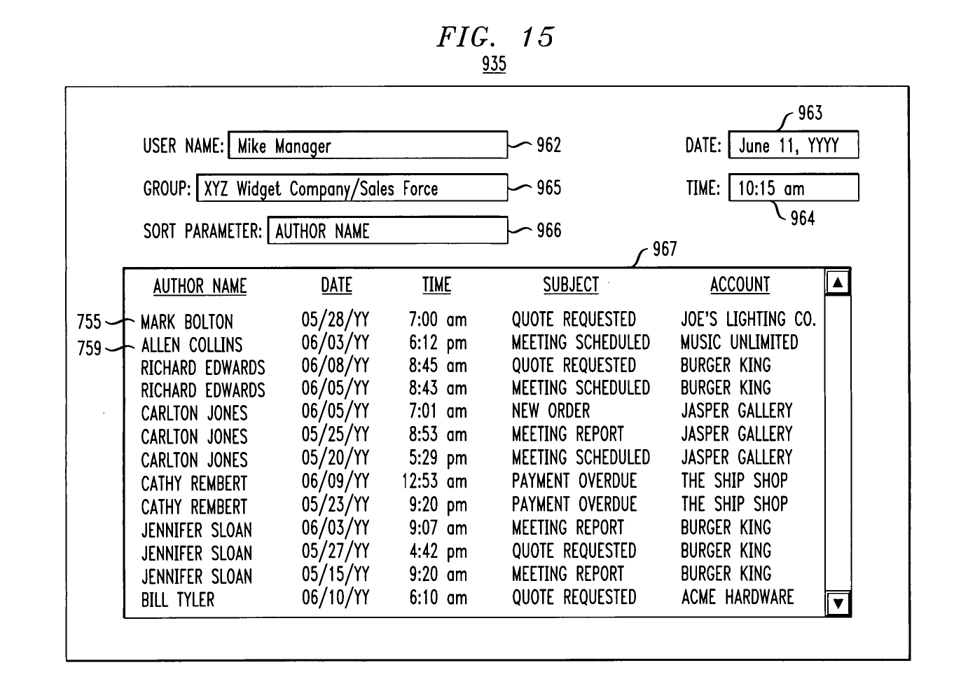

Mike Manager similarly is presented by voice server 230 with the menu of options shown in FIG. 6. In this instance, Mike wishes to hear the header information for recent records, and accordingly presses “2” for “review records.” FIG. 11 illustrates a routine for presenting information in response to a review records request. The routine of FIG. 11 is referred to as the “Review Records” routine. Mike's review request is received at step 910. At step 912, gateway 231 accesses CRM group folder 875. Gateway 231 also causes a Home GUI such as that shown in FIG. 12 to be displayed on terminal 220. Home GUI 935 includes user name field 962, date field 963, time field 964, group field 965, sort parameter field 966, and display 967. The current date and time are entered into fields 963 and 964 automatically. Gateway 231 inserts the caller's user name automatically in field 962 based on the MDN received with the call information. In this instance, the user name is “Mike Manager.” The registered name of the group, in this instance “XYZ Widget Company/Sales Force,” is entered in field 965, again based on the MDN. Because the records in CRM group folder 875 by default are chronologically arranged, gateway 231 initially sets “DATE/TIME” for Sort Parameter field 966.

At step 915, gateway 231 retrieves selected header information for each record from CRM group folder 875. In this example, information for author name, date, time, subject, and account are retrieved for each record, and are shown in display section 967. In alternative embodiments, other information may be retrieved and displayed. In this example, a limited number of records are shown, beginning with the most recent record, because display section 967 is not large enough to display all of the records stored in CRM group folder 875. The operator may access the remaining records by scrolling down display section 967 in a well-known manner.

At step 918, the operator reads to Mike Manager the header information for all the records in CRM group folder 875, one record at a time. After the header information for all records in CRM group folder 875 has been conveyed to Mike Manager, the call is transferred to voice server 230, which again presents menu 401 (shown in FIG. 5) in an automated voice.

In an alternative embodiment, voice server 230 may perform the role of the operator, and read the selected header information for each record to the caller. In that embodiment, at any time during a caller's interaction with voice server 230, the caller may say “Menu” (or, alternatively, press a predetermined key on his/her telephone) to cause menu 401 to be played. For example, if Mike Manager says “Menu” at any time during the “Review Records” routine, voice server 230 uses its voice recognition capabilities to interpret Mike's voice utterance and determine the desired request. In response, the “Review Records” routine stops and voice server 230 reads the options shown in menu 401. Similarly, if a caller wishes to return immediately to the operator, he/she may say “Operator.” In response, voice server 230 stops reading the record, and the caller is reconnected to the operator.

In another embodiment, information in a record may be stored in the form of digital audio recordings corresponding to different fields in the record. Accordingly, in order to read header information to a caller in response to a review request, gateway 231 may cause a playback device (not shown) to replay the audio recordings associated with various fields of each respective record.

Suppose that as the operator is reading header information for various records in response to Mike Manager's review records request, Mike wishes to hear the complete version of a particular record, say, record 768 generated by Bill Tyler on June 10. Accordingly, Mike asks the operator to play record 768 (or, alternatively, presses a predetermined key on his telephone while the pertinent header information is being read by voice server 230). FIG. 13 illustrates a routine for playing a selected record to a caller, in accordance with an embodiment of the invention. The routine of FIG. 13 is referred to as the “Play Record” routine. Upon receiving the play record request (step 1071), the operator selects record 768, e.g., by clicking on the record in display section 967. In response, gateway 231 causes Record GUI 530 (shown in FIG. 7) to be displayed on terminal 220. At the same time, data in each field of record 768 is retrieved, as indicated at step 1074, which populates the corresponding field of Record GUI 530. At step 1078, the operator reads the information from each field of GUI 530 to Mike Manager. Alternatively, voice server 230 may perform the role of the operator and read the information in record 768 to Mike.

After the Play Record Routine is completed (i.e., the data from all fields in GUI 530 have been read to the caller), gateway 231 causes Home GUI 935 to be displayed again on terminal 220 and populates the respective fields with the data that was on display immediately prior to the play record request. Gateway 231 then re-activates the “Review Records” routine, causing voice server 230 to begin reading header information starting with the next record.

While the information in a record is being read or after it has been read by the operator, a caller may wish to delete the record. In such case, the caller may ask the operator to delete the record. In response, the operator may select an appropriate option on terminal 220, causing a signal containing the delete command to be transmitted to gateway 231. Having determined that Mike Manager's access rights include the right to delete a record, gateway 231 causes the respective record to be deleted from CRM group folder 875.

In the alternative embodiment in which the record is being played by voice server 230, the caller may say “Delete” either during the Play Record routine or within a configurable amount of time after the Play Record routine ends. The caller's request to delete the selected record is received by voice server 230, and in response voice server 230 transmits a signal containing a delete command to gateway 231. Upon receiving the signal, gateway 231 causes the selected record to be deleted accordingly. Also in this embodiment, if while the information in a record is being read (e.g., during the Play Record routine), a caller wishes to skip the remainder of the record and hear header information for the next record immediately, the caller may say, “Next.” In response, voice server 230 stops reading the current record, and gateway 231 activates the “Review Records” routine, causing voice server 230 to begin reading header information starting with the next record. Similarly, a caller may say, “Previous” to listen to the header information concerning a previous record. In response to the caller's request, voice server 230 stops reading the current record, and gateway 231 activates the “Review Records” routine, starting with the record immediately prior to the current record. If the caller wishes to hear a record again after it has been read, he/she may say “Repeat,” and in response, voice server 230 reads the record again to the user.

In another embodiment, a registered caller may cause the records in CRM group folder 875 to be sorted according to a selected parameter. Suppose, for example, that Mike Manager wishes to hear the records in CRM group folder 875 sorted by name of author. Accordingly, at menu 401 he presses (3) to select “sort records.” In response, voice server 230 uses its voice recognition capabilities to interpret Mike's voice utterance and transmits a signal containing the selection to gateway 231. In response, gateway 231 causes voice server 230 to present an additional menu of options, including the following:

Press (1) to sort records by date;

Press (2) to sort records by name of author;

Press (3) to sort records by subject;

Press (4) to sort records by account.

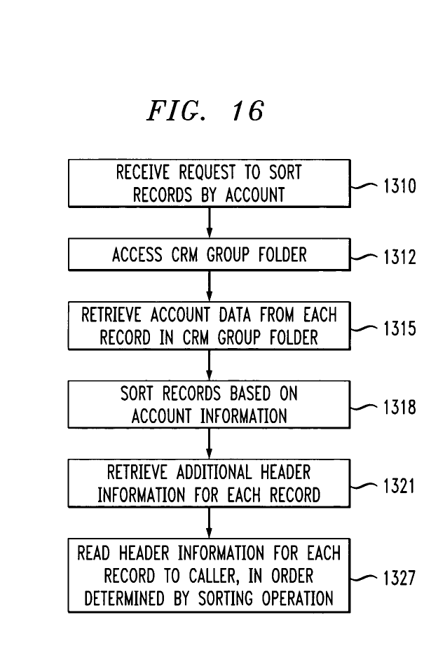

In this instance, Mike presses “2” to select “sort records by name of author.” FIG. 14 is a flowchart depicting a routine for sorting records in response to a caller's request to sort records by name of author. After the request is received (step 1110), gateway 231 accesses CRM group folder 875 at step 1112.

Gateway 231 causes Home GUI 935 to be displayed on terminal 220. Fields 962 (author name), 963 (date), 964 (time), and 965 (group) are completed automatically by gateway 231. Because Mike Manager requested that records be sorted by author name, gateway enters “AUTHOR NAME” in sort parameter field 966.

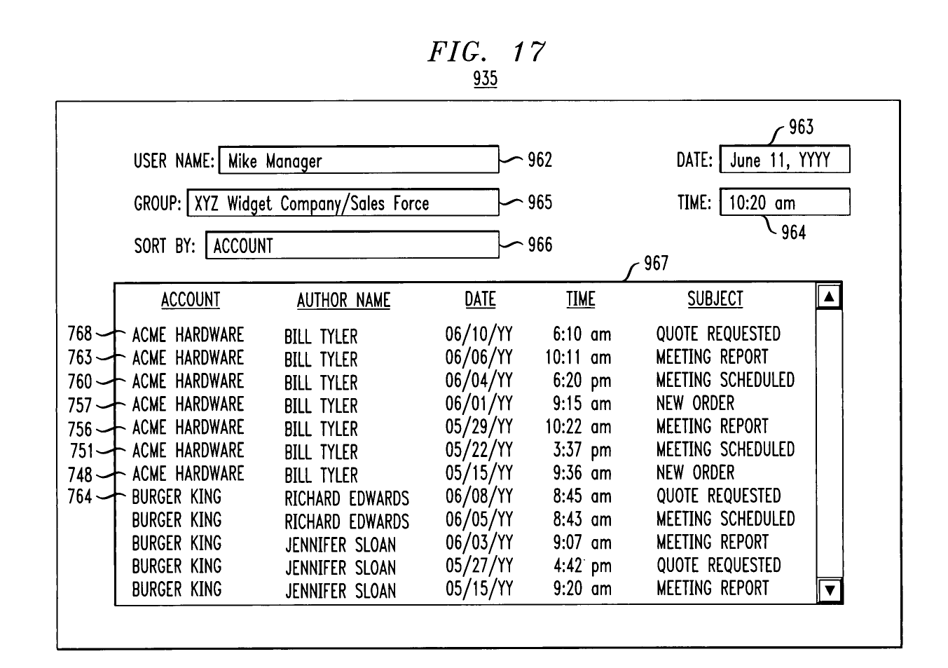

At step 1115, gateway 231 retrieves data from author name field 731 in each record of CRM group folder 875, and at step 1118 sorts the records based on the author name information. In the illustrative example, gateway 231 alphabetizes the author name data (based on last names). At step 1121, gateway 231 retrieves additional header information for each record in CRM group folder 875, and causes the header information to be displayed in GUI 935 in the order determined by the sorting operation. FIG. 15 shows Home GUI 935 in which the records from CRM group folder 875 are sorted by author name. In this example header information for author name, date, time, subject, and account is displayed in display section 967 of Home GUI 935; however, in alternative embodiments, other header information may be displayed. Record 755, generated by Mark Bolton on May 28, YYYY, and record 759, generated by Allen Collins on June 3, YYYY, are the first two records in the alphabetized list. At step 1127, the operator reads the header information for each record to Mike Manager, in the order in which they appear on Home GUI 935.

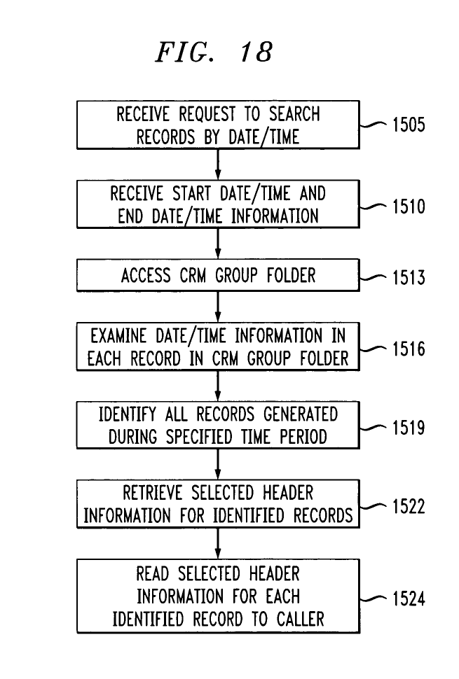

Suppose instead that Mike Manager wishes to hear the records in CRM group folder 875 sorted by account. Accordingly, he presses “4” at the menu shown above to select “sort records by account.” FIG. 16 is a flowchart depicting a routine for sorting records in response to a caller's request to sort records by account. After the request is received (step 1310), gateway 231 accesses CRM group folder 875 at step 1312.

Gateway 231 causes Home GUI 935 to be displayed on terminal 220. Fields 962 (author name), 963 (date), 964 (time), and 965 (group) are completed automatically by gateway 231. Because Mike Manager requested that records be sorted by account, gateway enters “ACCOUNT” in sort parameter field 966.

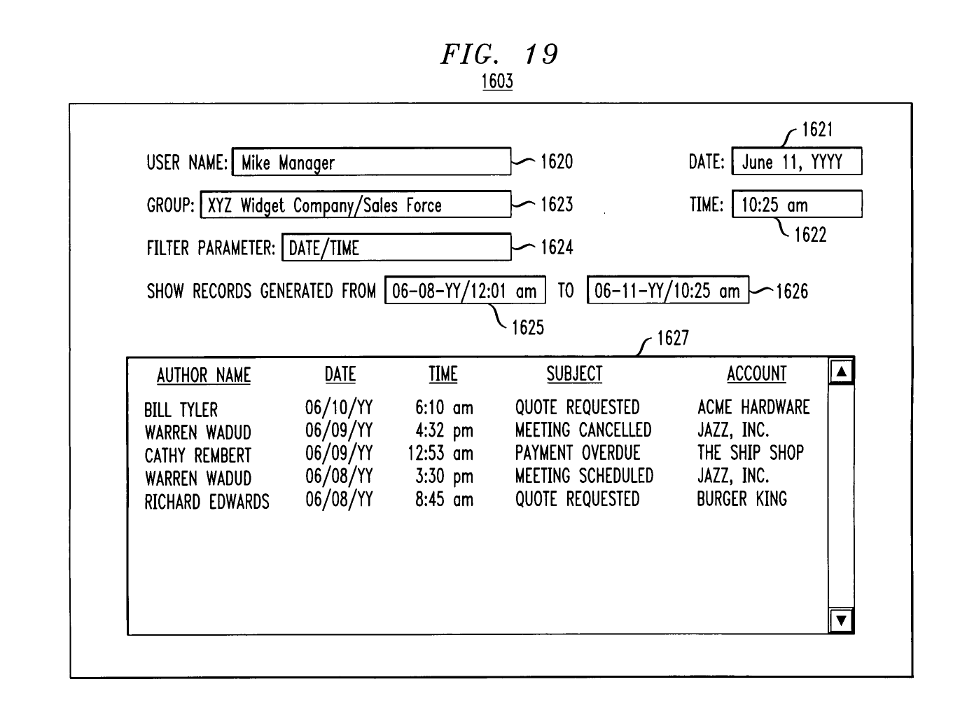

At step 1315, gateway 231 retrieves data from account field 735 in each record of CRM group folder 875, and at step 1318 sorts the records based on the account information. In the illustrative example, gateway 231 alphabetizes the account data. At step 1321, gateway 231 retrieves additional header information for each record in CRM group folder 875, and causes the header information to be displayed in Home GUI 935 in the order determined by the sorting operation. FIG. 17 shows Home GUI 935 in which the records from CRM group folder 875 sorted by account. Records 768, 763, 760, 757, 756, 751, and 748, all of which pertain to Acme Hardware and were generated by Bill Tyler, occupy the first seven places on the sorted list. Following the Acme Hardware records, records pertaining to Burger King are listed, starting with record 764. At step 1327, the operator reads the header information for each record to Mike Manager, in the order in which they appear on Home GUI 935.

A registered caller may alternatively search for one or more records based on a selected parameter. For example, suppose that Mike Manager wishes to hear information concerning only those records generated during the past three days, i.e., since June 8, YYYY. Accordingly, at menu 401 he presses (4) to select “search for records.” In response, voice server 230 presents an additional menu of options, including the following:

Press (1) to search records by date;

Press (2) to search records by name of author;

Press (3) to search records by subject;

Press (4) to search records by account.

In this instance, because Mike Manager is interested only in those records generated during the past three days, he presses “1.” FIG. 18 illustrates a routine for providing information concerning records filtered by date, in accordance with an embodiment of the invention. After the request is received to search records by date (step 1505), gateway 231 causes a Filter GUI such as that shown in FIG. 19 to be displayed on terminal 220. Filter GUI 1603 comprises fields 1620 (user name), 1621 (date), 1622 (time), and 1623 (group), which are populated automatically by gateway 231. Because Mike Manager requested that records be searched by date, gateway 231 enters “DATE/TIME” in filter parameter field 1624. The operator asks Mike Manager to specify values representing the start date/time and end date/time for the time period which interests him; when the operator receives this information (step 1510), it is entered in fields 1625 and 1626. In this instance, Mike Manager is interested in records generated during the past three days. Thus the operator enters corresponding parameters in fields 1625 and 1626, specifically “06/08/YY 12:01 a.m.” (representing the beginning of the third day preceding the present day) and “06/11/YY 10:25 a.m.” (representing the current time). In an alternative embodiment, voice server 230 may perform the role of the operator and elicit this information from Mike Manager.

At step 1513, gateway 231 accesses CRM group folder 875, and at step 1516 examines the date field 732 of each record stored therein. At step 1519 gateway 231 identifies all records generated during the specified time period and, at step 1522, retrieves selected header information for the identified records. Gateway 231 causes the header information for the identified records to be displayed in display section 1627 of Filter GUI 1603. In this instance, five records were generated during the specified time period and are shown in display section 1627. At step 1524, the operator reads the header information to Mike Manager. In an alternative embodiment, voice server 230 functions in the role of the operator and reads the header information.

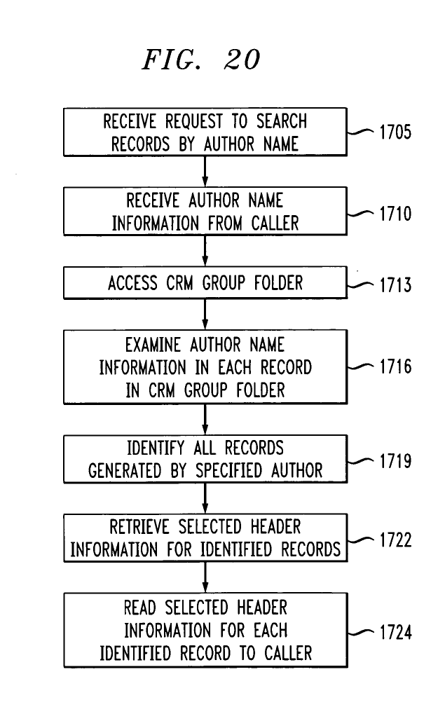

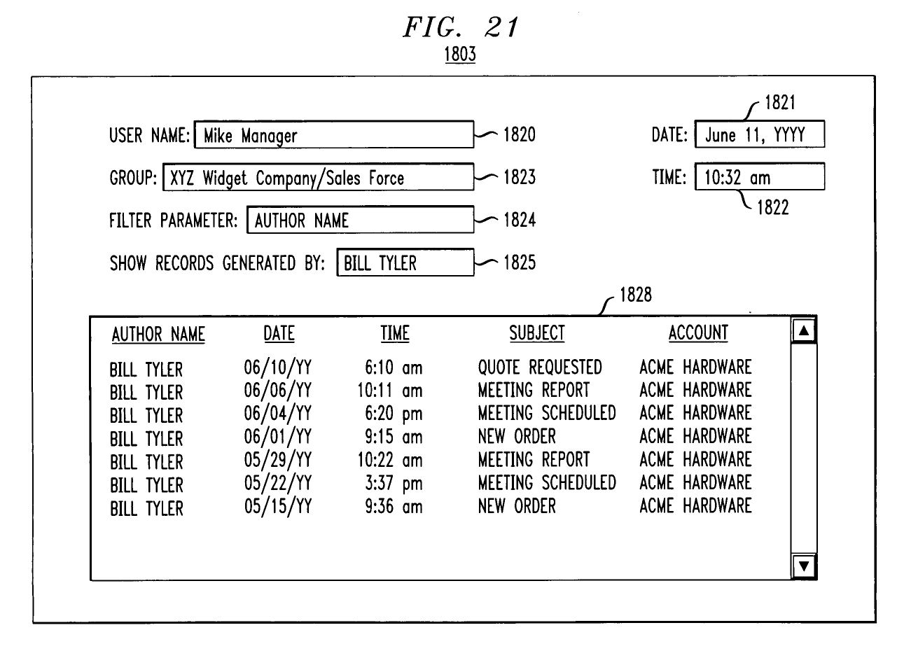

Other search modes are available. Suppose, for example, that Mike Manager wishes to hear information concerning only those records generated by a particular individual, say, Bill Tyler. Accordingly, at the menu shown above, he presses (2) for “search records by name of author.” FIG. 20 is a flowchart depicting a routine for providing information concerning records filtered by author name, in accordance with an embodiment. After the request is received to search records by author name (step 1705), gateway 231 causes a Filter GUI such as that shown in FIG. 21 to be displayed on terminal 220. Filter GUI 1803 comprises fields 1820 (user name), 1821 (date), 1822 (time), and 1823 (group), which are populated automatically by gateway 231. Because Mike Manager requested that records be searched by author name, gateway 231 enters “AUTHOR NAME” in filter parameter field 1824. The operator asks Mike Manager to specify the name of the author whose records he wishes to hear; when the operator receives this information (step 1710), it is entered in fields 1825. In this instance, Mike Manager is interested in records generated by Bill Tyler. Thus, the operator enters “BILL TYLER” in field 1825. In an alternative embodiment, voice server 230 may perform the role of the operator and elicit this information from Mike Manager.

At step 1713, gateway 231 accesses CRM group folder 875, and at step 1716 examines the author name field 731 of each record stored therein. At step 1719 gateway 231 identifies all records generated by the selected author and, at step 1722, retrieves selected header information for the identified records. Gateway 231 causes the header information for the identified records to be displayed in GUI 1803. In this instance, seven records were generated by Bill Tyler and are listed in display section 1828 of GUI 1803. At step 1724, the operator reads the header information to Mike Manager.

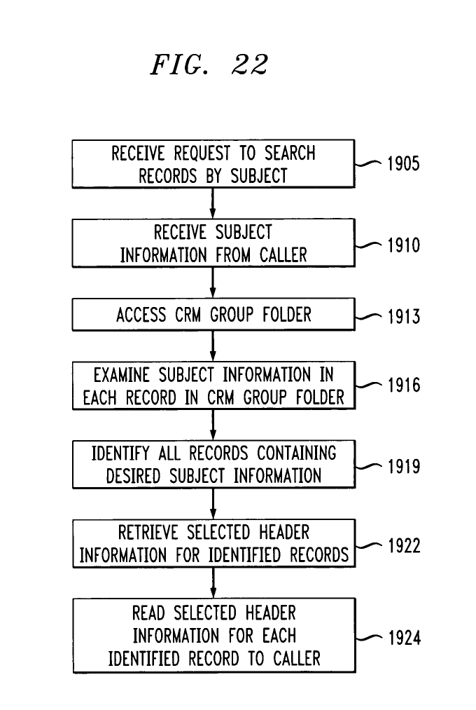

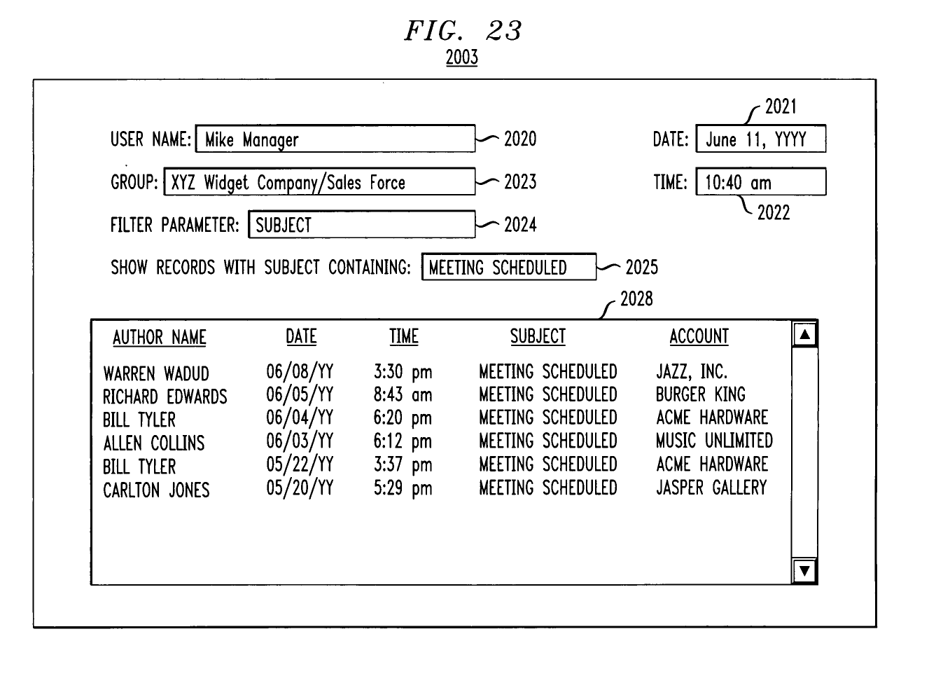

Mike Manager may also wish to hear information concerning only those records that pertain to a particular subject, say, scheduled meetings, so that he can decide whether or not to attend any of the upcoming meetings. Accordingly, at the menu shown above, he presses (3) for “search records by subject.” FIG. 22 is a flowchart depicting a routine for providing information concerning records filtered by subject, in accordance with an embodiment. After the request is received to search records by subject (step 1905), gateway 231 causes a Filter GUI such as that shown in FIG. 23 to be displayed on terminal 220. Filter GUI 2003 comprises fields 2020 (user name), 2021 (date), 2022 (time), and 2023 (group), which are populated automatically by gateway 231. Because Mike Manager requested that records be searched by subject, gateway 231 enters “SUBJECT” in filter parameter field 2024. The operator asks Mike Manager to specify the subject that he wishes to search for; when the operator receives this information (step 1910), it is entered in fields 2025. In this instance, Mike Manager is interested in records containing “Meeting Scheduled” in the subject field. Thus, the operator enters “MEETING SCHEDULED” in field 2025. In an alternative embodiment, voice server 230 may perform the role of the operator and elicit this information from Mike Manager.

At step 1913, gateway 231 accesses CRM group folder 875, and at step 1916 examines the subject field 734 of each record stored therein. At step 1919 gateway 231 identifies all records containing “Meeting Scheduled” in subject field 734 and, at step 1922, retrieves selected header information for each of the identified records. Gateway 231 causes the header information for the identified records to be displayed in GUI 2003. In this instance, six records were found pertaining to “Meeting Scheduled” and are listed in display section 2028 of GUI 2003. At step 1924, the operator reads the header information to Mike Manager.

In another embodiment, a caller may request that a search for records within a CRM group folder be performed based on multiple parameters. For example, Mike Manager may wish to hear the header information for records generated by Jennifer Sloan (author name) between June 1, YYYY and June 10, YYYY (date/time range). Mike's request may be received and transmitted to gateway 231 either by an operator or by voice server 230. In response to such a request, gateway 231 accesses CRM group folder 875 and retrieves records satisfying the desired parameters. In this instance, gateway 231 finds only one record generated by Jennifer Sloan during the specified time period, namely record 758, created on June 3. Accordingly, gateway 231 provides header information for record 758 to the operator, who reads the header information to Bill.

The foregoing merely illustrates the principles of the invention. It will thus be appreciated that those skilled in the art will be able to device numerous other arrangements that embody the principles of the invention and are thus within the spirit and scope of the invention, which is defined by the claims below.

Finally, information/call center 200 and its components are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for providing an information assistance service facilitating entry of information to a server, comprising:
receiving a voice call from a user, the voice call including a request for entry of information to the system, information being organized in records in the server, the records being associated with one or more folders, each record comprising a plurality of fields therein;
automatically deriving identity information concerning the user from call set-up signals associated with the voice call;
eliciting from the user verbal information for filling one or more fields of a record;
converting the verbal information to data corresponding thereto;
filling the one or more fields of the record with the data;
associating the user with a selected one of the folders based on the identity information; and
transmitting the record to the server, where the record is stored in association with the selected folder.

2. The method of claim 1 wherein the information assistance service also provides a directory assistance service.

3. The method of claim 1 wherein the server includes a customer relationship management (CRM) system.

4. The method of claim 1 wherein the identity information includes an automatic number identification (ANI).

5. The method of claim 1 wherein the data includes textual data.

6. The method of claim 1 wherein the data includes audio data.

7. The method of claim 1 wherein the selected folder is associated with a group, and the user is a member of the group.

8. The method of claim 1 wherein the verbal information is elicited from the user by an information assistance provider.

9. The method of claim 8 wherein the information assistance provider includes an operator.

10. The method of claim 8 wherein the information assistance provider includes a voice device.

11. The method of claim 1 wherein the voice call includes a telephone call.

12. A method for providing an information assistance service facilitating access to information maintained in a server, comprising:
receiving a voice call from a user, the call including a request for accessing information in the server, information being organized in records in the server, the records being associated with one or more folders, each record including a plurality of fields therein;
automatically deriving identity information concerning the user from call set-up signals associated with the call;
associating the user with a selected one of the folders based on the identity information;
in response to the request, identifying one or more records associated with the selected folder based on content in at least one of the fields of the one or more records; and
verbally conveying data in the identified records to the user.

13. The method of claim 12 further comprising determining whether the user has an access right to perform an action on the identified records.

14. The method of claim 13 wherein the action is performed on behalf of the user if it is determined that the user has the access right.

15. The method of claim 12 wherein the information assistance service also provides a directory assistance service.

16. The method of claim 12 wherein the server includes a CRM system.

17. The method of claim 12 wherein the identity information includes an ANI.

18. The method of claim 12 wherein the data includes textual data.

19. The method of claim 12 wherein the data includes audio data.

20. The method of claim 12 wherein the selected folder is associated with a group, and the user is a member of the group.

21. The method of claim 12 wherein the data is verbally conveyed by an information assistance provider.

22. The method of claim 21 wherein the information assistance provider includes an operator.

23. The method of claim 21 wherein the information assistance provider includes a voice device.

24. The method of claim 12 wherein the voice call includes a telephone call.

25. The method of claim 12 wherein the one or more records are identified as a result of a search with the content satisfying one or more criteria.

26. The method of claim 25 wherein the one or more criteria concern a given time.

27. The method of claim 25 wherein the one or more criteria concern a given subject.

28. The method of claim 25 wherein the one or more criteria concern a given source of data in the one or more records.

29. The method of claim 12 wherein the one or more records are identified as a result of sorting of records associated with the selected folder.

30. A system for providing an information assistance service facilitating entry of information to a server, comprising:
a first interface for receiving a voice call from a user, the voice call including a request for entry of information to the system, information being organized in records in the server, the records being associated with one or more folders, each record comprising a plurality of fields therein;
a processing unit programmed to automatically derive identity information concerning the user from call set-up signals associated with the voice call;
a mechanism for eliciting from the user verbal information for filling one or more fields of a record, the verbal information being converted to data corresponding thereto, the one or more fields of the record being filled with the data;
a processor programmed to associate the user with a selected one of the folders based on the identity information; and
a second interface for transmitting the record to the server, where the record is stored in association with the selected folder.

31. The system of claim 30 wherein the information assistance service also provides a directory assistance service.

32. The system of claim 30 wherein the server includes a CRM system.

33. The system of claim 30 wherein the identity information includes an ANI.

34. The system of claim 30 wherein the data includes textual data.

35. The system of claim 30 wherein the data includes audio data.

36. The system of claim 30 wherein the selected folder is associated with a group, and the user is a member of the group.

37. The system of claim 30 wherein the verbal information is elicited from the user by an information assistance provider.

38. The system of claim 37 wherein the information assistance provider includes an operator.

39. The system of claim 37 wherein the information assistance provider includes a voice device.

40. The system of claim 30 wherein the voice call includes a telephone call.

41. A system for providing an information assistance service facilitating access to information maintained in a server, comprising:
an interface for receiving a voice call from a user, the call including a request for accessing information in the server, information being organized in records in the server, the records being associated with one or more folders, each record including a plurality of fields therein;
a processing unit programmed to automatically derive identity information concerning the user from call set-up signals associated with the call;
a processor programmed to associate the user with a selected one of the folders based on the identity information, in response to the request one or more records associated with the selected folder being identified based on content in at least one of the fields of the one or more records; and
a mechanism for verbally conveying data in the identified records to the user.

42. The system of claim 41 wherein an action is performed on the identified records on behalf of the user if it is determined that the user has an access right to perform the action.

43. The system of claim 41 wherein the information assistance service also provides a directory assistance service.

44. The system of claim 41 wherein the server includes a CRM system.

45. The system of claim 41 wherein the identity information includes an ANI.

46. The system of claim 41 wherein the data includes textual data.

47. The system of claim 41 wherein the data includes audio data.

48. The system of claim 41 wherein the selected folder is associated with a group, and the user is a member of the group.

49. The system of claim 41 wherein the data is verbally conveyed by an information assistance provider.

50. The system of claim 49 wherein the information assistance provider includes an operator.

51. The system of claim 49 wherein the information assistance provider includes a voice device.

52. The system of claim 41 wherein the voice call includes a telephone call.

53. The system of claim 41 wherein the one or more records are identified as a result of a search with the content satisfying one or more criteria.

54. The system of claim 53 wherein the one or more criteria concern a given time.

55. The system of claim 53 wherein the one or more criteria concern a given subject.

56. The system of claim 53 wherein the one or more criteria concern a given source of data in the one or more records.

57. The system of claim 41 wherein the one or more records are identified as a result of sorting of records associated with the selected folder.
